(19) United States
(12) Patent Application Publication
(10) Pub. No.: US 2013/0078377 A1
(43) Pub. Date: Mar. 28, 2013

(54) METHOD OF TREATING A FINISHED SURFACE

(71) Applicant: David Robert Lesnick, Avon, OH (US)

(72) Inventor: David Robert Lesnick, Avon, OH (US)

(21) Appl. No.: 13/628,652

(22) Filed: Sep. 27, 2012

Related U.S. Application Data
(60) Provisional application No. 61/539,906, filed on Sep. 27, 2011.

(51) Int. Cl. B05D 5/00; B05D 3/00; B05D 1/02; B05D 1/28; B05D 1/36; B05D 3/12

(52) U.S. Cl. 427/290; 427/402; 427/299; 427/407.1; 427/421.1; 427/429

(57) ABSTRACT

A method of treating a finished surface with a stain without penetrating the finished surface whereby the finished surface remains visible. A clear coat finish can be applied over the stained finished surface.

### CROSS-REFERENCE TO RELATED APPLICATIONS

This application claims the benefit of U.S. Provisional Patent Application No. 61/539,906 filed on Sep. 27, 2011, which is incorporated herein by reference.

### TECHNICAL FIELD OF THE INVENTION

The present invention relates generally to a method of treating a finished surface and more particularly to a method of treating a finished surface by applying a stain so that the finished surface remains visible.

### BACKGROUND OF THE INVENTION

It has long been desirable to produce wood products that are artistically and aesthetically pleasing to the public, yet preserved from the destructive agencies of wood. When the wood is new it exhibits a desirable color and grain, however, as the wood ages, it becomes gray and discolored. Wood that is colored and preserved is desirable for use in the home, and is also used in the siding, fencing, and decking industry. Unfortunately, many of the preservative solutions used to preserve wood from wood destroying organisms impart their own color to the wood. In many cases the coloration imparted by the preserving solution is undesirable for one reason or the other. Stains are typically semitransparent solutions or suspensions of coloring matter (such as dyes or pigments or both) in a vehicle, designed to color a surface by penetration without hiding it or leaving a continuous film. Wood stains are known, for example, from the furniture industry and are used for staining the surface of a piece of furniture while preserving its natural grain. For this purpose, the surfaces of the pieces of furniture are treated with the stain by, for example, painting or spraying. In such treatment processes the stain penetrates the wood surface only slightly, such that the grain of the wood may still be seen.

### SUMMARY OF THE INVENTION

According to an embodiment of the present invention, a method of treating a finished surface includes applying a stain to the finished surface without penetrating the finished surface whereby the finished surface remains visible. According to another embodiment of the present invention, a method of treating a finished surface, includes applying a semi-transparent stain to a finished surface without penetrating the finished surface whereby the stained finished surface remains visible; and applying a clear coat finish over the stained finished surface.

### BRIEF DESCRIPTION OF THE DRAWINGS

No drawings required.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

The present invention relates to a new method and application of treating a finished surface, including applying a stain to a finished surface without penetrating the finished surface whereby the finished surface remains visible. Within the terms of this description, a finished surface includes a textured surface, such as porous red oak, and a non-textured surface such as maple or metal. This method can change the color of a finished wood surface without sanding or stripping off the existing finish. The previously known method for staining utilizes latex-based finishes which are not transparent in nature. Rather, they are opaque and do not allow the wood grain to show through. Further, their durability is poor.

The present embodiment uses a stain that is transparent and be regulated as to the depth and darkness of the final finish. It is also within the terms of the invention that the stain be semi-transparent. When applied, the stain doesn't hide the finished surface. Also, the method provides for applying the stain such that is does not leave a continuous film of the stain. The transparent or semi-transparent stain is formed of a pigment, solvent and a binder.

The first step in the method is to including prepare the finished surface prior to applying the stain to the finished surface. The surface that is to be stained is cleaned, and then treated with a degreaser, such as “Mighty Boss Degreaser” by Zoom Cleaning Products, LLC of Winchester, Tenn. A deglosser may also be used on the surface, such as “Wil-Bond Deglosser” by National Paint Ind. of North Brunswick, N.J. The method further includes preparing the finished surface by sanding the surface after degreasing it. A sanding sponge or sanding paper may be used for this purpose.

Once the finished surface has been prepared, the desired color and brand of stain is selected. One such stain is “Duraseal Quick Coat,®” made by the Minwax Company of Upper Saddle River, N.J. It is also within the terms of the embodiment that the stain be created by mixing wax free, liquid shellac with a concentrated dye. One brand of shellac to be used is Bullseye Seal Coat®” by Zinsser Co. of Somerset, N.J. The shellac can be mixed with a dye such as “TransTint® Concentrated Dye,” made by Homestead Finishing Products of Cleveland, Ohio.

The selected stain may be applied in any appropriate manner to the surface, such as with a spray gun, a brush, or a sponge. One spray gun that may be used is the “Accuspray® #10 HVLP Turbine Spray Gun.” If using a spray gun, it should be held an appropriate distance from the surface, such as six inches from the tip of the spray gun. It is possible that when a heavy-bodied stain, such as a Duralseal oil based stain is used, some stain splattering may occur. If so, it is with the terms of the method to add a thinner selected from the group of paint thinner and mineral spirits until no splatter spots remain to the oil based stains.

After the spray has been applied, and the desired color achieved, time must be given to allow for the stain to dry. The drying time may vary depending on the type of stain that was used.

Once the stain has had sufficient time to dry, the stained finished surface can be prepared prior to applying a coat of clear coat. This preparation includes sanding the stained finished surface and cleaning off the sanded surface. This sanding may be accomplished utilizing a 3M Superfine Sanding Sponge Pad, and then the sanding surface may be cleaned with an air hose or vacuum.

After the stained finished surface is prepared, the method includes applying a clear coat finish over the stained finished surface. The clear coat finish is selected from the group consisting essentially of varnish, oil based polyurethane, water based polyurethane and a water based catalyzed floor finish. One suitable type of clear coat is a floor finish for the ultimate in durability.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A method of treating a finished surface, comprising;
applying a stain to a finished surface without penetrating the finished surface whereby the finished surface remains visible.

2. The method of claim 1 including applying the stain onto the finished surface without hiding the finished surface.

3. The method of claim 2 including applying the stain onto the finished surface without leaving a continuous film of the stain.

4. The method of claim 2 including applying a semi-transparent stain.

5. The method of claim 4 including applying a semi-transparent stain formed of a pigment, solvent and a binder.

6. The method of claim 2 including preparing the finished surface prior to applying the stain to the finished surface.

7. The method of claim 6 including preparing the finished surface prior to applying the stain to the finished surface by degreasing the surface.

8. The method of claim 7 including preparing the finished surface by sanding the surface after degreasing the surface.

9. The method of claim 1 including applying the stain by a spray gun.

10. The method of claim 1 including applying the stain by a brush.

11. The method of claim 1 including applying the stain by a sponge.

12. The method of claim 2 including applying a clear coat finish over the stained finished surface.

13. The method of claim 12 wherein the clear coat finish is selected from the group consisting essentially of varnish, oil based polyurethane, water based polyurethane and a water based catalyzed floor finish.

14. The method of claim 12 including preparing the stained finished surface prior to applying a clear coat finish over the stained finished.

15. The method of claim 14 including preparing the stained finished surface by sanding and cleaning off the sanded surface.

16. The method of claim 15 including applying a stain of wax free, liquid shellac mixed with concentrated dye.

17. The method of claim 16 including mixing the stain with a thinner selected from the group of paint thinner and mineral spirits.

18. A method of treating a finished surface, comprising;
applying a semi-transparent stain to a finished surface without penetrating the finished surface whereby the stained finished surface remains visible; and
applying a clear coat finish over the stained finished surface.

19. The method of claim 18 including preparing the finished surface prior to applying the stain to the finished surface.

20. The method of claim 15 including applying a semi-transparent stain of wax free, liquid shellac mixed with concentrated dye.
